(19) United States
(12) Patent Application Publication
(10) Pub. No.: US 2012/0137316 A1
(43) Pub. Date: May 31, 2012

(54) Media information system and method

(76) Inventors: Kirill Elizarov, Sunny Isles Beach, FL (US); Peter Elizarov, Perm (RU)

(21) Appl. No.: 13/066,171

(22) Filed: Apr. 8, 2011

Related U.S. Application Data
(60) Provisional application No. 61/458,724, filed on Nov. 30, 2010.

(51) Int. Cl. H04H 60/33

(52) U.S. Cl. 725/9

(57) ABSTRACT

A system and method of the inventive concept is adaptable to receive information (graphic and audio) generated and affected by direct viewer participation and to be aired to the viewers. The system and method of the present invention provides a unique approach for mass media communication channels wherein the information content to be presented to the viewers is determined not by the management of the television channel but by the viewers actively voting for the topics of their interest and participating in the discussion in the open air.

### RELATED APPLICATIONS

This is a non-provisional application that claims priority to a provisional application Ser. No. 61/458,724 filed on Nov. 30, 2010 and incorporated herewith by reference in its entirety.

### FIELD OF INVENTION

This invention pertains generally to the field of mass media information systems and methods.

### BACKGROUND OF THE INVENTION

Television is an integral part of human live. Web based mass media is an integral part of human live. Television and web media are the major source of information about at least news, sports, politics, and entertainment available to public. From the middle of the past century life of the billions people determined by television, which teaches us how we must live and what we have to do. The television has not been learning how to involve TV watchers for dialog so far. We have a choice to change channels, but we can't interact with television. These opportunities we have got in social media. But here your voice is getting lost in the millions of another voices. If you want to be heard by users from neighborhood, you have to be like celebs from TV. This process is becoming circular and tautological.

Typical television and web media present a serial process wherein a television program or web site interface have a series of images and sounds broadcasted to viewers, but the viewers have limited opportunity or no opportunity at all to participate in the television program or in the web site content. The evolution to a more interactive form of television, or television where the viewer is allowed to participate, was slow given the lack of bidirectional communication channels between the viewer and the television program broadcaster or and the web site owner. When bidirectional communication channels were created, they tended to be of insufficient bandwidth for communication of complex viewer interactions with the television program or web site.

Past century brought new version of network communication of Internet that was expanded into interactive web television. However, viewer participation has been limited to choosing television content, responding to advertising messages, and answering viewer questionnaires or polls. This is primarily because most interactive television programming follows a conventional television paradigm wherein the television programming is wrapped in advertisements; and the only responses needed from an audience are to watch linear pre-recorded programs and to buy advertised items or services.

Little has been done to fully involve the audience in a rich participatory experience where the audience has as much control and influence over the content of an interactive program as the originator of the interactive program or interactive content of web site. This is in contrast to the expectations of some viewers, who want a richer and more satisfying participatory experience within the context of an interactive program. In general however, television channels and most influence web sites are controlled by a certain corporations or government. All information provided to the viewers is censored and controlled by the television channel and web sites. In reality, the traffic of news is “unidirectional”, i.e. viewers can see the information (news, music, commercials, etc.) but cannot comment or participate ‘live’ unless the viewer emails his/her comments or calls the television channel directly for any comments, complains, etc. Therefore, the comments, such as interesting stories, comments, either video or audio or both available with respect to a particular news and available to be viewed or listened by other are not available and cannot be shared, discussed, commented, etc.

One of the alternatives to conventional television is Internet television otherwise known as Internet TV, Web TV or Online TV. Internet television is a television service distributed via the Internet. Some Internet television is known as catch-up TV. Internet television allows the users to choose the program or the television show they want to watch from an archive of programs or from a channel directory. The two forms of viewing Internet television are streaming the content directly to a media player or simply downloading the program to the user's computer. With the “TV on Demand” market growing, these on-demand websites or applications are a must have for major television broadcasters. Similar to the conventional television, all information provided to the viewers is censored and controlled by the management of the Internet TV, wherein the traffic of news is “unidirectional”, i.e. viewers can see the information (news, music, commercials, etc.) but cannot comment or participate ‘live’ unless the viewer email his/her comments or calls the television channel directly for any comments, complains, etc. Therefore, the comments, such as interesting stories, comments, either video or audio or both available with respect to a particular news and available to be viewed or listened by other are not available and cannot be shared, discussed, commented, etc.

Another alternative is Web television, also commonly referred to as Web TV. Web TV is an emerging genre of digital entertainment that is distinct from traditional broadcast television. Delivered originally online via broadband and mobile networks, Web television shows, or Web series, are short-form in nature (2-9 minutes per episode), episodic, and produced in seasons. Similar to the conventional television and Interned TV all information provided to the viewers is censored and controlled by the management of the Web television, wherein the traffic of news is “unidirectional”, i.e. viewers can see the information (news, music, commercials, etc.) but cannot comment or participate ‘live’ unless the viewer emails his/her comments or calls the television channel directly for any comments, complains, etc. Therefore, the comments, such as interesting stories, comments, either video or audio or both available with respect to a particular news and available to be viewed or listened by other are not available and cannot be shared, discussed, commented, etc.

The art is replete with various prior art references teaching different methods and systems of television. United States Patent Publication No. 20090282430 to Gupta teaches systems and methods for collecting viewership data of television and radio broadcast programs. The methods include receiving an AV signal of a broadcast program and supplementary content that contains a tag identifying the broadcast program. The supplementary content is combined with the AV signal to form a data-augmented signal which is subsequently modulated with a carrier signal to form a transmit signal for broadcasting to receivers. Each receiver includes a decoder for extracting the supplementary content and recording the tag identity and time the tag is received. The recorded information is subsequently output to an electronic device or sent directly to a viewership data collection entity.

Another reference, namely United States Patent Publication No. 20030196206 to Shusman teaches a method and system for the creation of interactive programming incorporating viewer interactions. An interactive program includes moderator content generated by the moderator and edited participant commentary, such as interactive messages, and is served by a moderator server. Moderators create and manage interactive programs using a Web site. Viewers register to be participants in interactive programs using the Web site as well. The interactive programs can be distributed as electronic documents written in a markup language such as HTML or XML over a communications network such as the Internet. The interactive programs can also be converted to conventional interactive television content for distribution over an interactive television network. The interactive programs can also be distributed over a virtual private network for use as a collaboration tool by an enterprise such as a business concern. The interactive programs require few processing resources so the interactive programs can be embedded within other Web processes such as electronic commerce and television commerce transactions.

### SUMMARY OF THE INVENTION

A mass media system of the present invention provides an inventive approach to modern media: to select from the user generated content (UGC), which circulates inside the groups of users, the topics most commented by users; to select the most searchable topics of content presented at the web based search engines; to create the mixed content from selected UGC, and from selected content presented at the web based search engines; to create the broadcast from mixed content and from different types of offline content brought on/by means of different types of media; to air broadcast to the group of users through Television channel, Web channel, Mobile channel, Radio channel; to receive feedback from the group of users via Web devices, Mobile devices and telecommunication devices—thus creating a mass media with broadcast, the content of which is the same for all groups of users and is determined by the groups of users, in accordance with their mood and interests at the moment of airing by the mass media system.

The mass media system includes a first device, hence the first software system is operably communicated with a plurality of web based search engines (such as for example, Yahoo, Google, Buidu, search engine of Facebook, search engine of Twitter, search engine of CNN, and etc.), for continuously tracking in the open Web the topics most commented by the users and for forming selected groups of topics most commented by the users.

Also, the first software system is configured to receive directly from users a various types of web based user generated content (UGC): one type of UGC is delivered with the help of Web devices; another type of UGC is delivered with the help of Mobile devices integrated with the Web, and yet another type of UGC is delivered with the help of another telecommunication devices integrated with the Web.

At the final step the first software system allows the content taken from the web based search engines and the web based different types of UGC brought on Web devices, Mobile devices and other telecommunication devices to converge into a special type of mixed content.

The mass media system includes a second device, i.e. an offline unit. The software system of the offline unit is operably communicated with the first software system. The software system of the offline unit is configured to receive the mixed content from the first software system, and is configured to receive different types of offline content brought on/by means of offline media. The offline unit is a telecommunication device that is operably communicated with the first device and is based in a place, where the different types of offline content brought on/by means of offline types of media (i.e. telephone calls, books, people, anchor of mass media system, photo, DVD, CD, etc) are being accumulated 24/7 in open air of the mass media system. The offline unit converts visible light rays and audible sound into electrical waves.

The software system of the offline unit calculates the amount of the mixed content (received via the first device), and calculates the amount of the offline content, selecting each of the most commented topics of the mixed and offline content to determine the score of each of the most commented topics thereby separating the most commented topics according to the score to select the topic with the highest score. The second software system is configured to receive the most commented topics from the groups of users in response to the broadcast presented to the groups of users with the help of telecommunication channels of the mass media system. The users vote for the topics of the broadcast of their choice, i.e. the topic that each particular user wants to discuss, and provide the UGC, that the user believes to be interesting and worth sharing with the others in the next circle of further broadcast of the mass media system.

The anchorman of the mass media system, who is a part of the offline unit, changes the topics for discussion as the score of one topic being discussed and transmitted is changed by the higher score of another topic. Also the anchor of mass media system moderates, edits the users discussion of the elected topic. Offline users participate in discussion in broadcast of the mass media system through various telecommunication devices, which are to be connected to the offline unit. Online users participate in a discussion in broadcast of the mass media system with the help of mixed content, which is to be delivered to the offline unit by virtue of the first device. Anchorman of mass media system, and online users, and offline users are interact and communicate each other in the broadcast of mass media system. The users from the groups of users present their feedback (their opinions, comments, offering new aspects of the topic and theme and demand to change and take totally new topic for further discussion) to the anchorman of the mass media system, who is a part of the second device, i.e. of the offline unit of the mass media system.

The software system of the offline unit has an extender software, which is configured to converge all types of the received mixed and offline content into broadcast and is configured to increase the time of the topic being discussed from the pre-programmed time of broadcast to the extended time based on popularity and input of the mixed and offline content.

The mass media system includes a controller, which is a telecommunication device that is operably communicated with the offline unit, i.e. the second device, i.e. a software system of the controller is operably communicated with the software system of the offline unit and converts the received broadcast back into electrical waves for transmitting through Television channel, Web channel, Mobile channel, and Radio channel for presenting to the groups of users.

The mass media system of the present invention creates a bidirectional traffic of information, wherein the first direction of the traffic is the broadcast from the mass media system to the groups of users through Television channel, Web channel, Mobile channel, and Radio channel, and the opposite direction of traffic is the UGC delivered from the groups of users to the mass media system via Web devices, Mobile devices and telecommunication devices.

A method of circulating of the UGC i.e. of the transient images of fixed and/or moving objects together with sound, which have information value for a user, represents a continuous cycle of interaction between the mass media system and the groups of users, wherein the content self-replicates when circulating between the mass media system and the groups of users. In the process of circulating, the UGC develops into the selected topics of mixed content, catalyzes, modifies, transforms due to the offline content brought on/by means of offline types of media; converts into broadcast, which is later being aired to the groups of users and replicates itself by virtue of the activity of groups of users.

The method begins with continuously tracking in the open Web the topics most commented by the users, and receiving various types of web based user generated content (with the help of Web devices, Mobile devices and other telecommunication devices integrated with the Web) thereby with the help of first device forming selected topics of the mixed content.

The method continues with receiving the offline user generated content brought on offline types of media; converging the mixed content and offline content with the help of the extender software into the broadcast; converting the broadcast into relative types of broadcast with the help of the controller for airing through Television channel, through Web channel, through Mobile channel, and through Radio channel, etc. for presenting the broadcast to the groups of users. The method further continues with creating a new UGC with the help of groups of users in response to the received broadcast—thus the UGC reproduces itself and updates due to the activity of the groups of users. The method then calculates the number of the users from the groups of users selecting each of the most searchable topics of the UGC to determine the score of each of the most searchable topics. The method further includes the step of separating the most searchable topics of the UGC according to the score to select the topic with the highest score. The method allows to continuously monitor the UGC to select the topic with the highest score to be discussed by the users in the broadcast of the mass media system as the broadcast is being transmitted to the groups of users, and change the topics for discussion as the score of one topic being discussed and transmitted is changed by the higher score of another topic, thereby creating bidirectional traffic of the UGC between the users and the mass media system.

An advantage of the present invention is to provide a system and method that create an entirely new mass media system, wherein the content of the aired broadcast is determined and provided by the users and is based on the users generated content (UGC), and wherein each of the users from groups of users provides comments that include but are not limited to videos, audio recording, sound messages, text messages, images, etc.

Another advantage of the present invention is to provide a system and a method that allows a vast number of the users from the groups of users be on the air of the mass media system at the same time. This advantage allows hosting a vast number (e.g. thousands during one hour of airing by the mass media system) of “live” connections between the users and the system.

Still another advantage of the present invention is to provide a system and a method, wherein the groups of the users account hundreds of millions of participants that function as newsmakers, as nonprofessional correspondents for the network of the mass media system. Any user becomes a supplier of information that he/she sends to the mass media system; he/she does not get any salary or bonuses. The mass media system does not allocate money to support this huge nonprofessional network of the groups of users and does not bear any expenses to maintain the input of UGC.

Still another advantage of the present invention is to provide a system and a method, wherein any advertising message, put on the air of the mass media system, gets flash ‘live’ feedback in the form of UGC from the millions of participants of the group of users, thereby the owner of the advertising can quickly—contrary to the traditional mass media—evaluate the efficiency of their commercials.

Still another advantage of the present invention is to provide an improved system and method to increase subscriptions to the mass media system service provider.

Still another advantage of the present invention is to provide an improved system and method that enhances the viewership of a broadcast.

Still another advantage of the present invention is to provide a system and a method, wherein the new mass media system based on a certain group of users allows a company that is the owner of the accounts of the certain group of users to increase its market capitalization, which is one of the basic measures of a publicly-traded company. The new mass media system based on the certain group of users is a way to determine the rough value of a company that is the owner of the accounts of the groups of users.

Still another advantage of the present invention is to provide a system and a method, wherein millions of users around the world will have the opportunity to express their opinion and points of view on social and political issues, thereby asserting soft influence over the decisions of theirs governments and parliaments. This mass media system can be one more tool for democratization of the society.

Other advantages and meritorious features of this invention will be more fully understood from the following description of the preferred embodiment, the appended claims, and the drawings; a brief description of which follows.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a schematic view of system and method of the present invention presenting operable communication between the groups of users providing user generated content (UGC) to the mass media system through the telecommunication devices (Web devices, Mobile devices, traditional phones, and etc) and back interaction between the mass media system and the groups of users via telecommunication channels, a Television channel, a Web channel, a Mobile channel, and a Radio channel;

FIG. 2 illustrates a more detailed view of the initial step of the present method, wherein the anchorman of the mass media system determines the topics of the online and offline user generated content (UGC), which circulates inside the groups of users (social networks, email services, open Web, watchers, listeners, and etc), most commented by the users and the most searched topics of the content presented at the web based search engines for presenting these topics to the groups of users;

FIG. 3 illustrates a more detailed view of the further step of the present method, wherein the selected topic for discussion is determined by a score, i.e. the majority of the users decide to discuss the certain topic of the aired broadcast at the moment in time;

FIG. 4 illustrates a more detailed view of yet another step, wherein the users decide on discussing the selected topic and participate in the discussion in the broadcast of the mass media system through various telecommunication devices. The online users and offline users present their feedback (their opinions, comments, offering new aspects of the topic and theme and demanding to change and take a totally new topic for further discussion) to the anchorman of the mass media system, who is a part of the offline unit of the mass media system, via various communication devices such as, e.g. Web devices, mobile/cellular phones, text messages, phones, smart phones, tablets, etc;

FIG. 5 illustrates a more detailed view of yet another step illustrating interaction between input of the UGC from the online and offline groups of users to the broadcast of the mass media system and output of the broadcast in response thereto by an anchorman of the mass media system, who is a part of the offline unit of the mass media system;

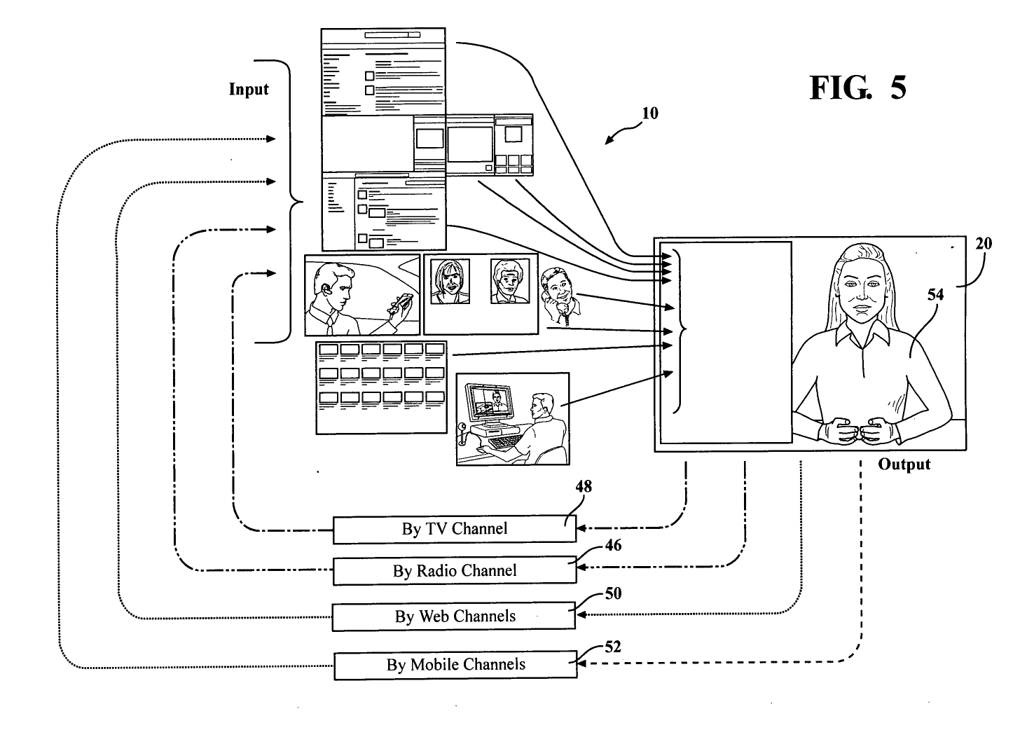

FIG. 6 illustrates a more detailed view of various situations, where each certain user from the groups of users can receive the broadcast aired by the mass media system through the telecommunication channels, and where this user can send the user generated content (UGC) via various types of telecommunication devices back to the mass media system;

FIG. 7 illustrates a more detailed view of circulating of the UGC by virtue of continuous cycle of interaction between the mass media system and the groups of users; and

FIG. 8 illustrates a schematic view of a time table presenting the segments of the airtime devoted to various topics and programs of the broadcast of the mass media system.

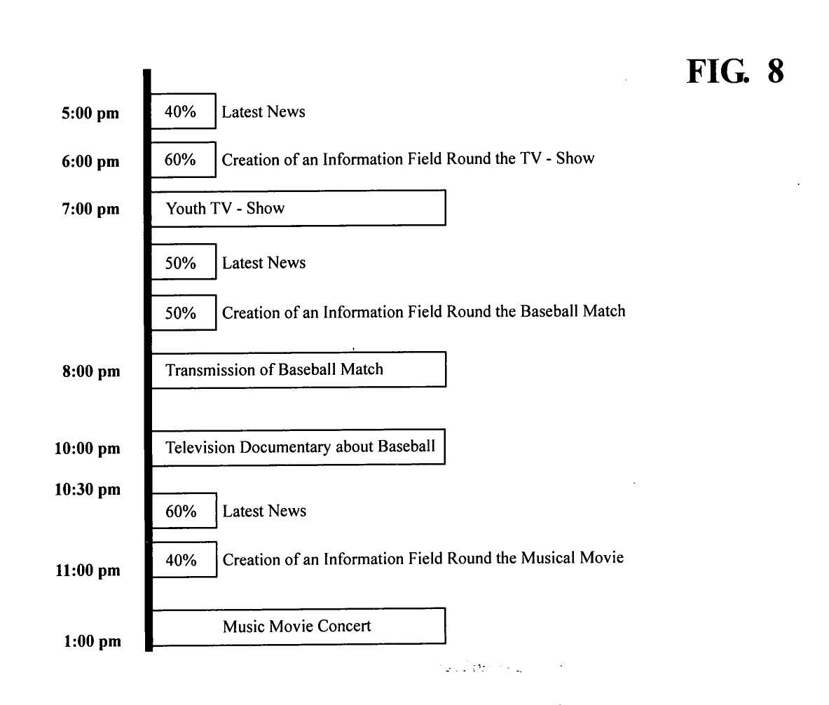

### DETAILED DESCRIPTION OF THE INVENTION

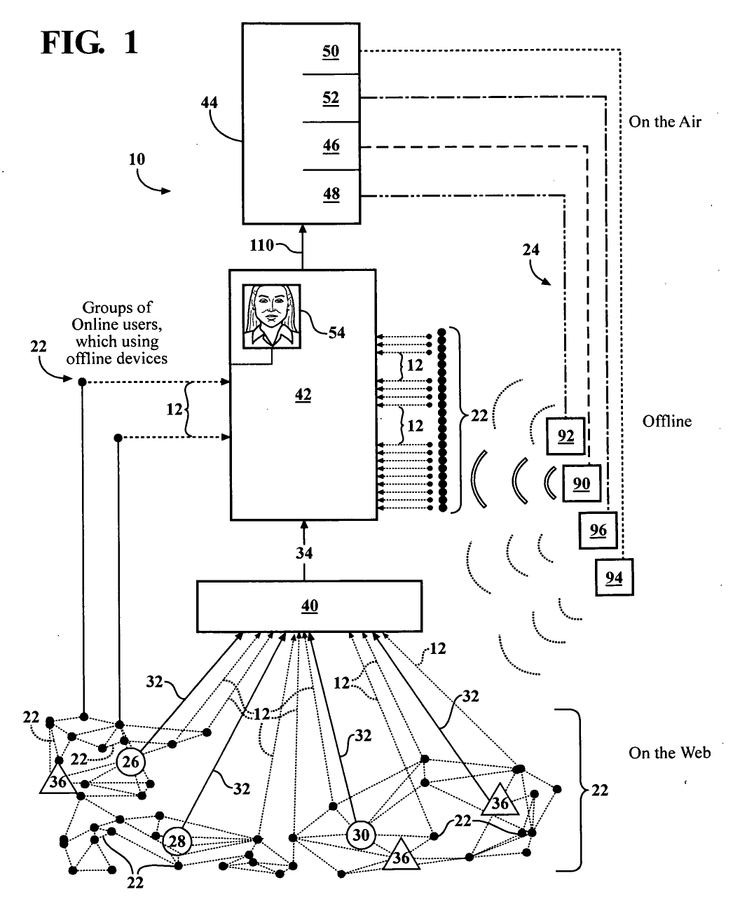

Referring to the Figures, wherein like numerals indicate like or corresponding parts throughout the several views, a concept of the present invention, the mass media system (the system) is generally shown indicated as 10 in FIG. 1. The following terms are used in the present application. Those skilled in the art will appreciate that other related terms with meanings may be used in description of the present invention and the terms used therein are not intended to limit the scope of the present invention. User means one who uses social network or/and webmail or/and mobile device or/and television device or/and Web device or/and radio device or/and telephone services or/and any open Web services (all services together or at least one of them). Group of users—(also users' group or users group or user group) is a group that uses a particular service. A group of users can account from several people to hundreds of millions of participants. Mass media is means of public communication reaching a large group of users. Broadcast (Air) is communication that is transmitted by mass media for the public or for general use. Telecommunication channel—the electronic system used in transmitting of broadcast. Telecommunication device—the electronic apparatus (at the first point of the telecommunication channel and at the end point of the telecommunication channel) used in sending or/and in receiving of broadcast. Telecommunication device converts broadcast content i.e. sound, images of fixed or/and moving objects into electrical waves for transmitting via telecommunication channel and reconverts electrical waves after transmitting via telecommunication channel into broadcast content. Television device (TV device) is a telecommunication device used in television technology, i.e. various types of TV receivers, etc. Mobile device is a telecommunication device used in mobile/cellular phone technology, i.e. various types of mobile phones, smart phones, etc. Web device is a telecommunication device used in Internet technology, i.e. various types of computers, laptops, tablets, etc. Radio device is a telecommunication device used in radio technology, i.e. various types of radio receivers, etc. Content is a combination of one or more elements of sound, images of fixed or/and moving objects, which has information value for a user. User generated content or user generated information (the UGC) is content created by nonprofessional user for noncommercial purpose. Television channel—is a system of telecommunication channels and television devices. Mobile channel—is a system of telecommunication channels and mobile devices or/and Web devices. Web channel—is a system of communication channels and web devices or/and Mobile devices. Radio channel—is a system of communication channels and radio devices. Anchorman is a person that moderates the broadcast of the mass media system.

The system 10 of the present invention provides an inventive approach to modern media wherein the topics 32 most commented by the users 22 presented at web based search engines 26, 28, 30, 36 and the UGC 12 generated by the online and offline groups of users 22, containing transient images of fixed object, such as pictures, text messages, emails, or/and moving objects transmitted through telecommunication devices, together with sound, are received by a first device 80 of the mass media system and transmitted back to the online and offline groups of users 22 i.e. participants, viewers, etc., through the telecommunication channels 46, 48, 50, 52 that with the help of telecommunication devices 90, 92, 94, 96 convert the broadcast 110 into the aired visible light rays and audible sound.

The system 10 includes the first device, hence the first software system 80 operably communicated with a plurality of web bases search engines 26, 28 (for instance Yahoo, Google, etc.), with social networks search engines 30 (for example, Facebook, Twitter, Buidu, etc.) and with search engines of conventional mass media 36 (for example, CNN, Bloomberg, Fox, etc.) for continuously tracking in the open Web the topics 32 most commented by the users 22 and for continuously receiving different types of the web based UGC 12 brought on Web, Mobile and other telecommunication devices integrated with the web, and generated by groups of users 22 for forming mixed content of topics 34 most commented by the users. This mixed content 34 of the most searched topics 32 is then presented to the groups of users 22 through the first device 40, the offline unit 42, the controller 44, the telecommunication channels 46, 48, 50, 52, and the telecommunication devices 90, 92, 94, 96 that convert the broadcast 110 into the aired visible light rays and audible sound. The number of the web based search engines is not intended to limit the scope of the present invention.

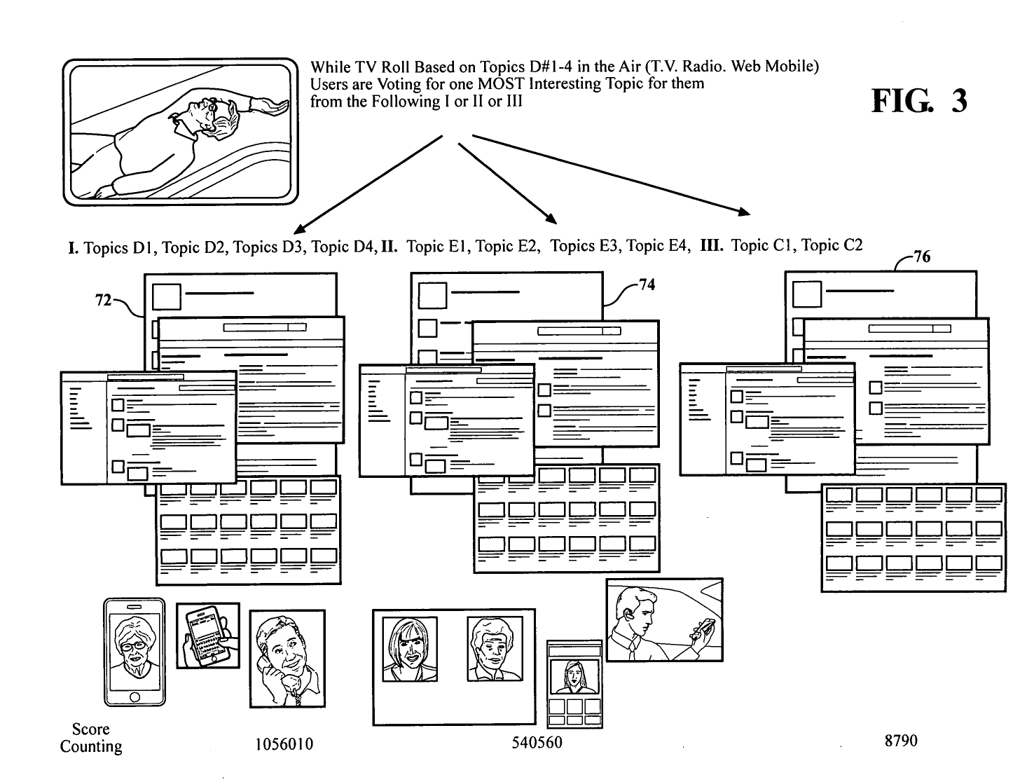

The offline unit 42 is operably communicated with the first device 40 and is configured to receive and circulate a voted score of the UGC 12 from the online and offline groups of users 22 in response to the selected topics of the mixed content 34 presented to the groups of users 22 by virtue of the broadcast 110. The offline unit 42 is adaptable to collect number of the users who vote for the selected topics of the mixed content 34 of their choice, i.e. the topic that each particular user wants to discuss, and provide the UGC 12 that the user considers to be interesting and is worth sharing with the others in the broadcast. The offline unit 42 includes a group of several software programs adaptable to calculate the number of the users 12 selecting each of the selected topics of the mixed content 34 to determine the score of each of the topics 34 thereby separating the most commented topics according to the score to select the topic with the highest score, indicated as 72 in FIG. 3.

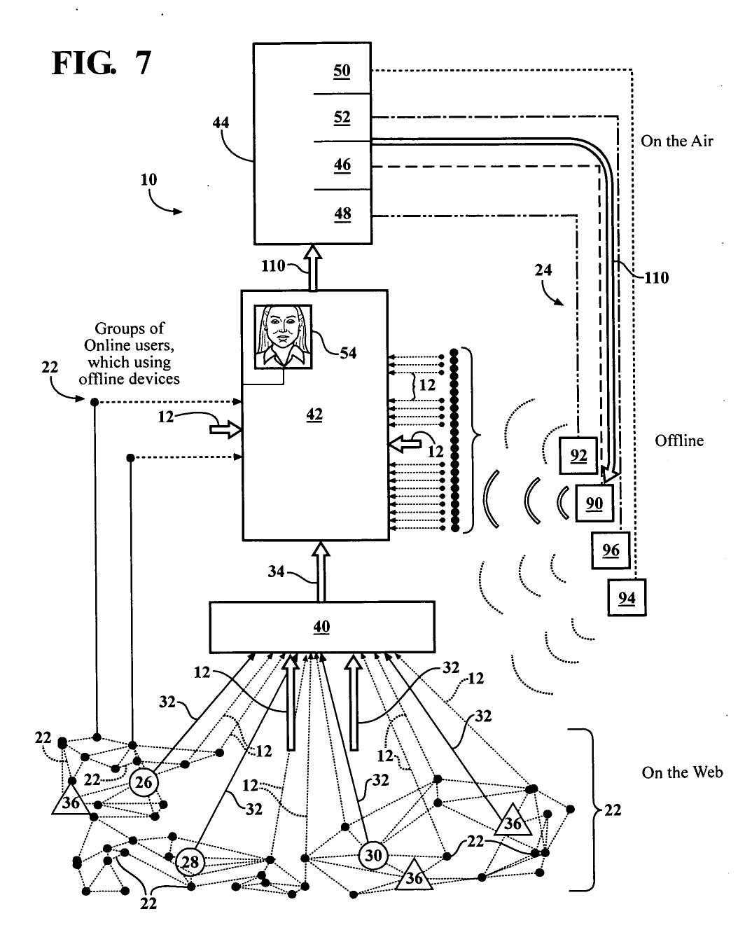

The offline unit 42 is operably communicated with the first device 40 for continuously monitoring the UGC 12 and selecting the topic from the mixed content 34 with the highest score 72 to be discussed by the users as the broadcast 110 is transmitted back to the online and offline groups of users 22, as shown in FIG. 7. The broadcast 110 is transmitted back to the online and offline groups of users 22 through a Radio channel 46, a TV channel 48, a Web channel 50, and a Mobile channel 52, as generally indicated and shown 24 in phantom lines in FIG. 1. The anchorman 54 of the mass media system, who is a part of the offline unit, changes the topics for discussion as the score of one topic being discussed and transmitted is changed by the higher score of another topic. The mass media system 10 of the present invention creates a bidirectional traffic of information, wherein the first direction of the traffic is the broadcast 110 from the mass media system 10 to the groups of users 22 through Television channel 48, Web channel 50, Mobile channel 52, and Radio channel 46, and the opposite direction of traffic is the UGC 12 delivered from the online and offline groups of users 22 to the mass media system 10 via Web devices 94, Mobile devices 96 and telecommunication devices 100.

An extender software of the software system of the offline unit 42 is connected to the controller 44 and is configured to converge all types of the received mixed 34 and offline user generated content 12 into broadcast 110 and is configured to increase the time of the topic being discussed from the pre-programmed time of broadcast 110 to the extended time based on popularity and input of the mixed 34 and offline UGC 12. The system 10 of the present invention provides a method of circulating of the content as more detailed shown in FIG. 7 that illustrates the view of circulating of the UGC 12 by virtue of the continuous cycle of interaction between the mass media system 10 and the online and offline groups of users 22, and the point of catalyzing, modifying, transforming the mixed content 34 due to the received offline UGC 12 and the anchorman of the mass media system 54.

The method begins with continuously tracking in the open Web the topics 32 most commented by the online users, and receiving various types of the web based user generated content 12, with the help of Web devices, Mobile devices and another telecommunication devices integrated with the Web, thereby with the help of the first device forming a group of the selected topics of the mixed content 34.

The method continues with presenting the mixed content 34, with the help of the anchorman of the mass media system 54; the method further continues with receiving the offline users generated content 12, which is the feedback of the groups of users 22 (their opinions, comments, offering new aspects of the topic and theme and demanding to change and take totally new topic for further discussion) to the anchor 54 of the mass media system; further continues with changing the topics for discussion as the score of one topic being discussed and transmitted is changed by the higher score of another topic; further continues with converging the catalyzed, modified, transformed offline UGC 12 and the mixed content 34 into the broadcast 110.

The method further proceeds with converting the broadcast 110 into electrical waves with the help of a controller 44 for transmitting through Television channel 48, through Web channel 50, through Mobile channel 52, and through Radio channel 46 for presenting to the online and offline groups of users 22. The method further includes the step of creating a new UGC 12 with the help of the online and offline groups of users 22 in response to the received broadcast 110—thus the UGC reproduces itself and is being updated due to the activity of the groups of users.

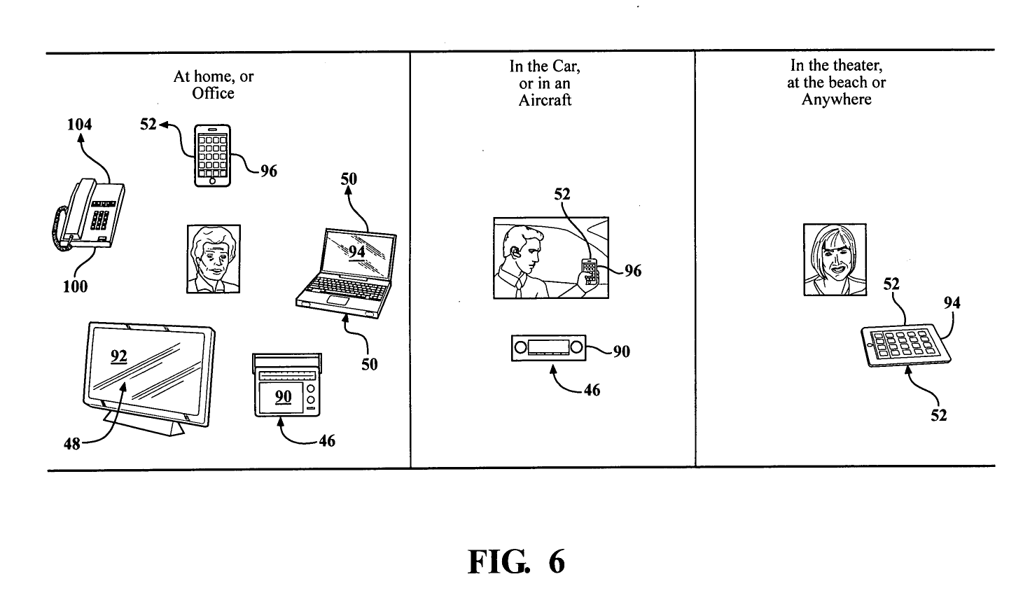

As shown at FIG. 6 in situation where a user is at home or at the office, etc., he/she can turn on the television device 92 of the television channel 48 of the present system 10 or/and, alternatively may turn on the radio device 90 of the radio channel 46 or/and may log in to the web channel 50 via web device 94 or/may turn on the Mobile channel 52 via the Mobile device 96. In all of these cases user will receive the broadcast 110 aired by virtue of telecommunication channels 46 (in FIG. 1) of the mass media system 10. In response to this broadcast 110 user can interact with the mass media system 10 with the help of various types of telecommunication devices (FIG. 1 and FIG. 6) located at his/her home or office. He/she may turn on Mobile device 96, alternatively, may log in to Web device 94 or/and may use a conventional telephone 100 connected with the mass media system via conventional telecommunication channels 104—thus sending his/her UGC 12 to the mass media system 10 via these telecommunication devices.

As best shown in FIG. 6, in situation where a user is in car or in an aircraft on the way or is in another similar situation, he/she may turn on the radio device 90 of the radio channel 46 for receiving broadcast 110 of the mass media system 10 and turn on Mobile device 96 of the mobile channel 96 for sending feedback 12 to the mass media system 10. Let us look at the user when in theater or in cinema or another similar situation, he/she may receive broadcast 110 and send back the UGC 12 with the help of web device 94 which using the mobile channel 52. Situations in which each individual user of the user groups 22 can receive broadcast 110 and send a respond with the UGC 12 may occur anywhere.

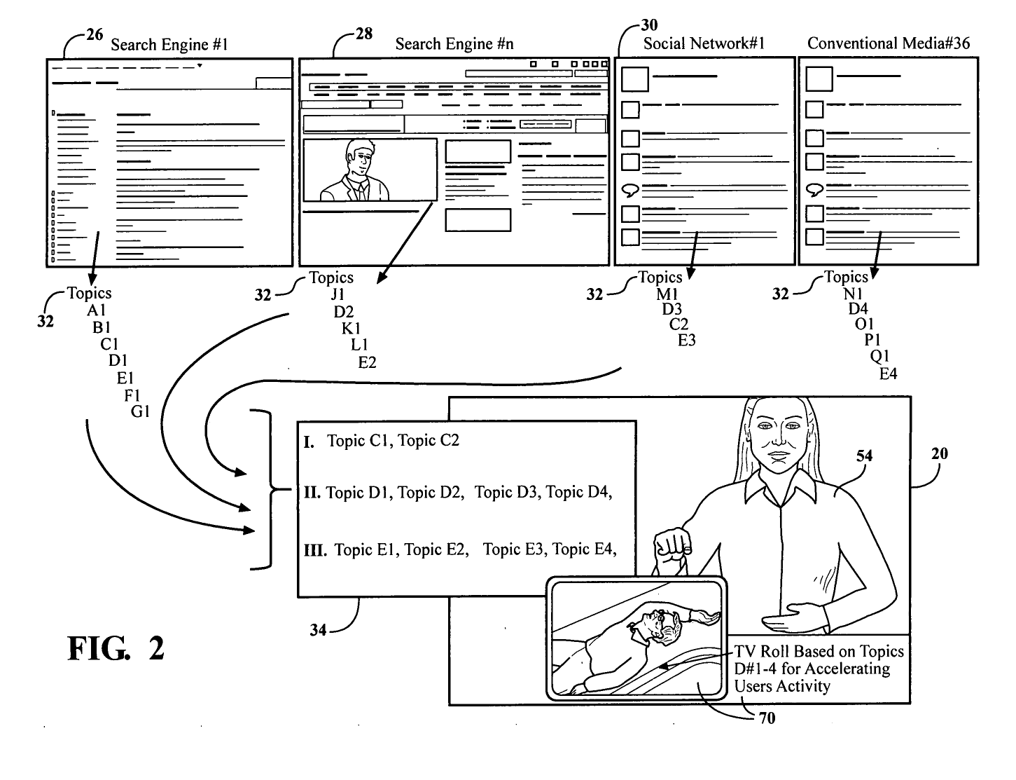

As best shown in FIG. 2, the anchorman of the mass media system 54, located at the offline unit 42, will announce that the search engines 26, 28, 30, 36 have identified the following topics or top news 32 such as news A1 through G1 from the first search engine, for example, topics 26, J1, D2, K1, L1, and E2 through the search engine 28, and topics such as M1, D3, C2, and E3 through the social network search engine 30. These topics will be selected by the system to the group of the selected topics 34.

While the process of selecting the most interesting topic is in progress, the anchorman 54 proceeds to discuss a topic 70 suggested by the online users 22 and that was brought to the offline unit 42 by virtue of telecommunication devices not integrated with the Web. As best shown in FIG. 3, the users will vote for the most interesting topic from groups 72, 74, and 76. The system 10 will determine the topic with the highest score to be discussed first by the users. For example, as shown in FIG. 3, the topic 72 has highest score of votes so the topic 72 will be discussed first.

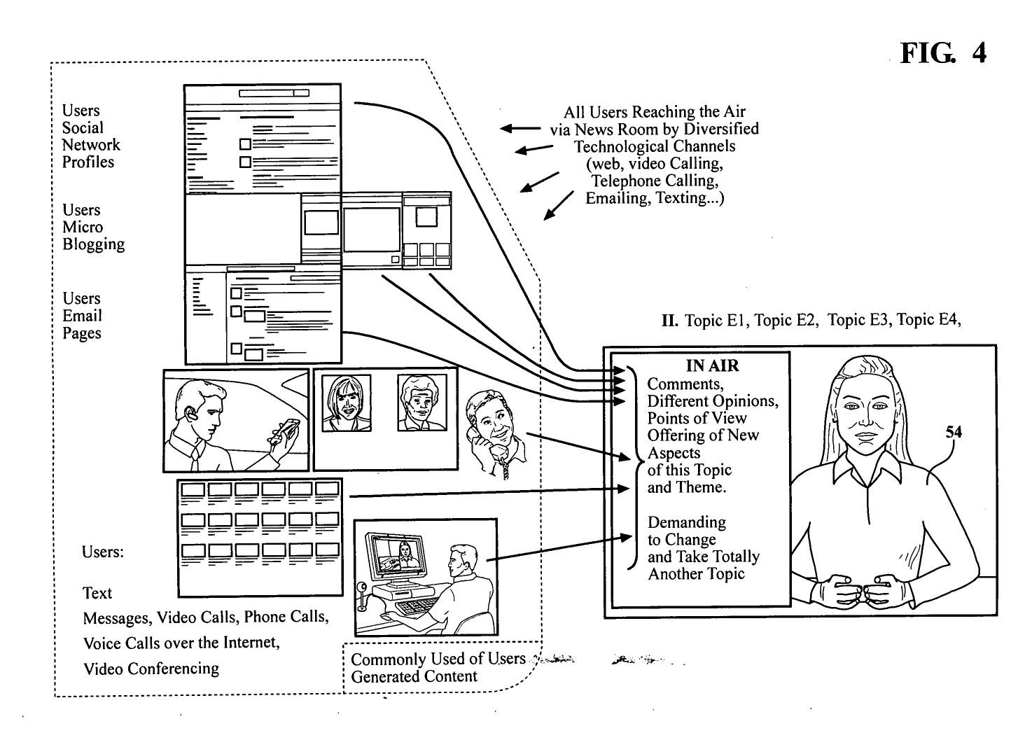

As best shown in FIG. 4, the online and offline users of groups of users 22 reach the mixed content 34 of the offline unit of the mass media system through various types of telecommunication devices. As the information is entered, the users will discuss openly their opinions, points of views thereby offering new aspects of the topics discussed and new themes.

As best shown in FIG. 7, the output of the offline unit 42 is the broadcast 110 that includes: mixed content 34 (which includes themselves web based UGC 12 and most commented topics 32) and the offline UGC 12. Preferably, each user willing to use the mass media system and to be a part of the “mass media world” will interact with the mass media and report about certain event.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A media system for receiving user generated content containing transient images of fixed and moving objects together with sound and for transmitting the user generated content to the users by apparatus that converts light and sound into electrical waves and reconverts the user generated content into visible light rays and audible sound, said media system comprising:
a first device operably communicated with a plurality of web bases search engines for continuously tracking in the open Web the topics most commented by the users, and is operably communicated with plurality of telecommunication devices is integrated with the Web for receiving various types of web based user generated content (UGC).
a second device operably communicated with said first device and configured to receive the offline user generated content from the groups of users in response to the mixed content delivered from the first device and presented to the users, and to calculate the number of the users selecting each of the most commented topics to determine score of each of the most commented topics thereby separating the most commented topics according to the score to select the topic with the highest score; and
a controller operatively communicated with said first device and said second device for continuously converting the broadcast received from the second device back into electrical waves to be transmitted through a Television channel, a Web channel, a Mobile channel, and a Radio channel for presenting said broadcast to the groups of users thereby creating bidirectional traffic of the user generated content.

2. A media system as set forth in claim 1 wherein said first device is further defined by the first software system for converging topics most commented by the users and web based user generated content into a special type of mixed content.

3. A media system as set forth in claim 1 wherein said second device is further defined by the second software system for receiving the offline user generated content and for converging the mixed content and offline content into broadcast.

4. A media system as set forth in claim 1 wherein said controller is further defined by a third software system for converting broadcast into electrical waves to be transmitted through telecommunication channels for presenting said broadcast to the groups of users.

5. A media system as set forth in claim 4 wherein said controller is further defined by a television channel.

6. A media system as set forth in claim 4 wherein said controller is further defined by a mobile channel.

7. A media system as set forth in claim 4 wherein said controller is further defined by a Web channel.

8. A media system as set forth in claim 4 wherein said controller is further defined by a radio channel.

9. A method of circulating user generated content containing transient images of fixed or/and moving objects together with sound between a media system and users comprising the steps of:
continuously tracking in the open Web the topics most commented by the users, and receiving various types of web based user generated content thereby forming selected topics of mixed content;
presenting the mixed content to the users, with the help of the anchorman of the mass media system;
receiving the offline users generated content containing transient images of fixed and moving objects together with sound, which is the feedback of the online and offline groups of users to the anchorman of the mass media system;
changing the topics for discussion as the score of one topic being discussed and transmitted is changed by the higher score of another topic;
converging the offline UGC and mixed content into the broadcast of the mass media system—thus the UGC reproduces itself and is being updated due to the activity of the online and offline groups of users.

10. A method as set forth in claim 9 including the step of incorporating a channel to electronically receive the user generated content containing at least one of transient images of fixed and moving objects together with sound and transmitting the user generated content to the online and offline users through telecommunication channels.

11. A method as set forth in claim 10 wherein the channel is further defined by a television channel.

12. A method as set forth in claim 10 wherein channel is further defined by a Web channel.

13. A method as set forth in claim 10 wherein channel is further defined by a mobile channel.

14. A method as set forth in claim 10 wherein channel is further defined by a radio channel.

15. A media system for receiving user generated content containing transient images of fixed and moving objects together with sound and transmitting the user generated content to the users by virtue of apparatus that converts light and sound into electrical waves and reconverts the user generated content into visible light rays and audible sound, said media system comprising:
a first device operably communicated with a plurality of web based search engines for continuously tracking in the open Web the topics most commented by the users, and operably communicated with a plurality of telecommunication devices integrated with the Web for receiving a various types of web based user generated content (UGC);
a second device operably communicated with said first device and configured to receive the offline user generated content from the groups of users in response to the mixed content delivered from the first device and presented to the users, and to calculate the number of the users selecting each of the most commented topics to determine the score of each of the most commented topics thereby separating the most commented topics according to the score to select the topic with the highest score;
a controller operatively communicated with said first device and said second device for continuously converting the broadcast received from second device back into electrical waves to be transmitted through Television channel, Web channel, Mobile channel, and Radio channel for presenting to the online and offline groups of users thereby creating bidirectional traffic of the user generated content;
a first software system for receiving and converging topics most commented by the users and web based user generated content into a special type of mixed content;
a second software system for receiving the mixed content and offline user generated content and for converging the mixed content and offline content into broadcast; and
a third software system for converting broadcast into electrical waves to be transmitted through telecommunication channels, a television channel, a Web channel, a mobile channel, and a radio channel for presenting to the online and offline groups of users.
